(19) United States
(12) Patent Application Publication
(10) Pub. No.: US 2025/0102881 A1
(43) Pub. Date: Mar. 27, 2025

(54) LENS CONTROL MECHANISM AND CONTROL DEVICE ADOPTING THE SAME

(71) Applicant: TILTA INC., Burbank, CA (US)

(72) Inventors: Wenping Zeng, Shenzhen (CN); Kefeng Zhou, Shenzhen (CN)

(21) Appl. No.: 18/378,361

(22) Filed: Oct. 10, 2023

(30) Foreign Application Priority Data
Sep. 27, 2023 (CN) 2022229498087

(51) Int. Cl. G03B 3/12; G03B 13/24

(52) U.S. Cl. CPC G03B 3/12; G03B 13/24

(57) ABSTRACT

The present disclosure relates to the technical field of cameras, and in particular, to a lens control mechanism, which includes a first control body, a driving assembly, and driving teeth for meshing with a lens, wherein the driving teeth are movably arranged on the first control body, the driving assembly is fixedly arranged on the first control body, the driving assembly is drivingly connected to the driving teeth, and the first control body is provided with a mounting position for mounting the lens control mechanism such that the driving teeth mesh with the lens. In the present disclosure, through the structural design of the mechanism, camera or lens parameters such as follow focus and zoom of the lens can be automatically controlled. Compared with manual adjustment, the parameter adjustment of the lens is more accurate and convenient.

### CROSS-REFERENCE TO RELATED APPLICATIONS

The present Application for patent claims priority to and the benefit of Chinese Application No. 2022229498087, filed Sep. 27, 2023, and hereby expressly incorporated by reference herein as if fully set forth below in its entirety and for all applicable purposes.

### TECHNICAL FIELD

The present disclosure relates to the technical field of cameras, and in particular, to a structure for controlling lens parameters.

### INTRODUCTION

At present, in the field of photography, photographers need to manually control the lens parameters to perform photography. This control method is not only troublesome but also cannot accurately adjust data or lens parameters by manual control.

For example, the prior art has disclosed an independent high-magnification visible light lens control device for photoelectric turntables (the application number is CN202021257237.5), which includes a supporting connecting rod, a motor rotating chamber, and a gear rotating chamber, wherein the bottom end of the supporting connecting rod is fixedly connected to the top of the motor rotating chamber through a fixing screw, two sides of the inner wall of the supporting connecting rod are fixedly connected to a rotating block and a fixed rotating block in turn from left to right, and one side of the supporting connecting rod is fixedly connected to a fixed supporting rod. This prior art relates to the technical field of lens control. The independent high-magnification visible light lens control device for photoelectric turntables enables the lens to rotate by 360 degrees in the horizontal direction through the components arranged in the motor rotating chamber, and enables the lens to rotate by 360 degrees in the vertical direction through the arrangement of the two sides of the inner wall of the supporting connecting rod. However, the control device cannot control some parameters such as follow focus and zoom of the lens.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In order to solve the above problems, the primary object of the present invention is to provide a lens control mechanism, which can control parameters (e.g., lens parameters) such as follow focus and zoom of the lens, such that the parameter adjustment is more convenient and more accurate.

Another object of the present invention is to provide a control device, which can control the camera and lens parameters.

In order to achieve the above objects, the technical schemes of the present invention are as follows.

A lens control mechanism includes a first control body, a driving assembly, and driving teeth for meshing with a lens, wherein the driving teeth are movably arranged on the first control body, the driving assembly is fixedly arranged on the first control body, the driving assembly is drivingly connected to the driving teeth, and the first control body is provided with a mounting position for mounting the lens control mechanism such that the driving teeth mesh with the lens. Specifically, the outer side of the external lens corresponding to the driving teeth is provided with teeth 31 that mesh with the driving teeth. After the mechanism is mounted through the mounting position, the driving teeth are engaged with the corresponding position of the lens, and the driving assembly drives the driving teeth to rotate, thereby driving the corresponding position of the lens to rotate, so as to achieve automatic control of parameters such as follow focus and zoom of the lens. The operation of the driving assembly may be controlled by providing a key on the mechanism, or by wired or wireless control through an external structure. All the above methods may be used. That is, through the structural design of the mechanism, the parameters such as follow focus and zoom of the lens can be automatically controlled. Compared with manual adjustment, the parameter adjustment of the lens is more accurate and convenient.

Further, the driving teeth are located at one end of the first control body, and the mounting position is a mounting hole located at the other end of the first control body. The driving teeth and the mounting holes are respectively arranged at the two ends of the first control body, such that the mechanism is more convenient to mount, and the mounting position is the mounting hole, which may be fixed on the external camera or a circular tube arranged on the bracket for mounting the external camera, such that the mounting of the mechanism can be achieved, and the mounting is more convenient.

Further, the first control body is movably provided with a first hand-twist assembly for locking an external circular tube in the mounting hole, and a front end of the first hand-twist assembly extends to a side edge of the mounting hole. The first hand-twist assembly locks the mechanism on the outer circular tube by twisting, which makes the mechanism more convenient to mount.

Further, the first control body is further provided with a first control key. The first control key can control the operation of the driving assembly.

A control device includes a lens control mechanism and a control handwheel mechanism wirelessly connected to an external camera, wherein the control handwheel mechanism is connected to the lens control mechanism, the control handwheel mechanism includes a second control body, a touch screen assembly for controlling the external camera or/and the lens control mechanism, and a handwheel assembly for controlling the external camera or/and the lens control mechanism, the touch screen assembly is fixedly arranged on the second control body, and the handwheel assembly is rotatably and movably arranged on the second control body. Specifically, the above “/” means “or”, the above control handwheel mechanism and the lens control mechanism may be connected by wires or wirelessly, and the specific implementation of the above wireless connection belongs to the prior art. Through the arrangement of the device, by the control handwheel mechanism, the driving assembly on the lens control mechanism can be controlled to automatically control parameters such as follow focus and zoom of the lens, and at the same time, the parameters on the external camera can be directly controlled by the control handwheel mechanism, that is, various parameters of the camera and the lens can be controlled by the control handwheel mechanism simultaneously, which is more convenient. The control handwheel mechanism is wirelessly connected to the external camera, such that the camera and lens parameters can be remotely controlled.

Further, the control handwheel mechanism is wirelessly connected to the lens control mechanism.

Further, the number of the lens control mechanisms is two or more (a first lens control mechanism and a second lens control mechanism), the first control body is provided with a plurality of first interfaces, the two lens control mechanisms are connected in series through the first interfaces, the second control body is provided with a second interface, and the control handwheel mechanism and the lens control mechanism are wired through the second interface and the first interfaces. The control handwheel mechanism may supply power to two lens mechanisms simultaneously.

Further, the handwheel assembly is arranged around the touch screen assembly. This arrangement makes the structural design of the control handwheel mechanism more reasonable, and makes the overall volume of the control handwheel mechanism smaller.

Further, the second control body is movably provided with a limit switch for limiting a rotation angle of the handwheel assembly.

Further, the second control body is further provided with a second key for controlling the external camera or/and the lens control mechanism.

Further, the second control body is further provided with a lever for controlling the lens control mechanism.

Further, the handwheel assembly and the touch screen assembly are located at one side of the second control body, the other side of the second control body is provided with a mounting groove, a first electronic contact pin is arranged in the mounting groove, a mounting assembly is detachably arranged in the mounting groove, the mounting assembly is electrically connected to the control handwheel mechanism through the first electronic contact pin, the mounting assembly is provided with a mounting position for detachably connecting an external device, and the mounting position is internally provided with a second electronic contact pin for electrically connecting with an external device.

The present invention has the advantages that through the structural design of the mechanism, the parameters such as follow focus and zoom of the lens can be automatically controlled. Compared with manual adjustment, the parameter adjustment of the lens is more accurate and convenient.

These and other aspects of the disclosure will become more fully understood upon a review of the detailed description, which follows. Other aspects, features, and implementations will become apparent to those of ordinary skill in the art, upon reviewing the following description of specific, exemplary implementations in conjunction with the accompanying figures. While features may be discussed relative to certain examples and figures below, all implementations can include one or more of the advantageous features discussed herein. In other words, while one or more implementations may be discussed as having certain advantageous features, one or more of such features may also be used in accordance with the various examples discussed herein. In a similar fashion, while examples may be discussed below as device, system, or method implementations, it should be understood that such examples can be implemented in various devices, systems, and methods.

### BRIEF DESCRIPTION OF THE DRAWINGS

FIG. 1 is a schematic diagram of a control device when it is matched with a lens and a camera according to some aspects of the disclosure.

FIG. 2 is a schematic diagram of a lens control mechanism from the first angle of view according to some aspects of the disclosure.

FIG. 3 is a schematic diagram of the lens control mechanism from the second angle of view according to some aspects of the disclosure.

FIG. 4 is an exploded view of the lens control mechanism according to some aspects of the disclosure.

FIG. 5 is a schematic diagram of the structure of a control handwheel mechanism from the first angle of view according to some aspects of the disclosure.

FIG. 6 is a schematic diagram of the control handwheel mechanism from the second angle of view according to some aspects of the disclosure.

FIG. 7 is a sectional view of the control handwheel mechanism according to some aspects of the disclosure.

FIG. 8 is a first explosion diagram of the control handwheel mechanism according to some aspects of the disclosure.

FIG. 9 is a schematic diagram of the control handwheel mechanism and a mounting assembly before mounting according to some aspects of the disclosure.

FIG. 10 is a second explosion diagram of the control handwheel mechanism according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. In some practical settings, devices incorporating described aspects and features may also necessarily include additional components and features for the implementation and practice of claimed and described examples.

In order to make the object, technical schemes, and advantages of the present disclosure clearer, the present disclosure will be further described in detail with reference to the accompanying drawings and embodiments. It should be understood that the specific embodiments described here are intended for illustrating the present disclosure, but not for limiting the present disclosure.

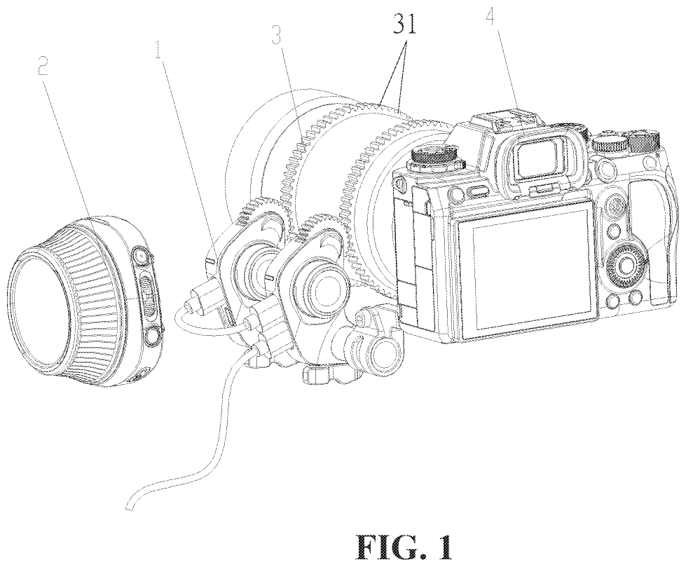

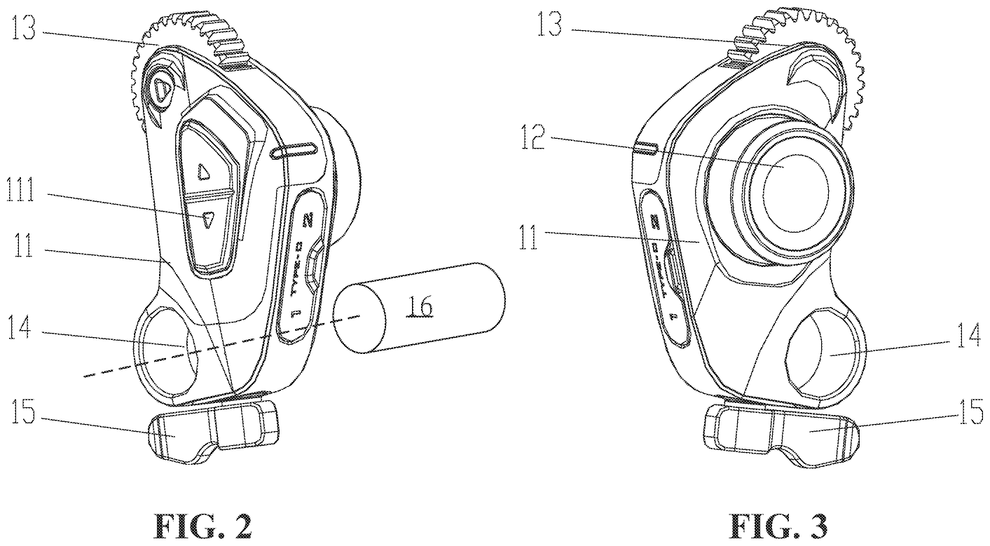

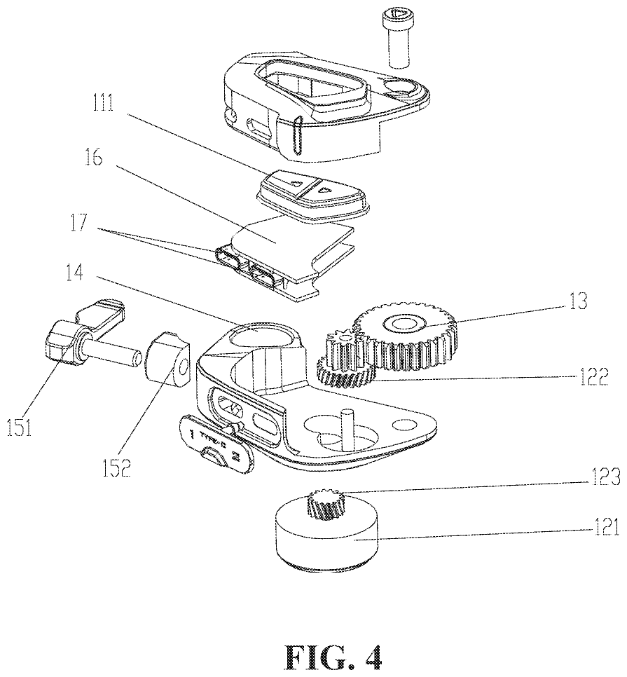

Referring to FIGS. 1 to 4, a lens control mechanism 1 includes a first control body 11, a driving assembly 12, and driving teeth 13 for meshing with the lens 3, wherein the driving teeth 13 are movably arranged on the first control body 11, the driving assembly 12 is fixedly arranged on the first control body 11, the driving assembly 12 is drivingly connected to the driving teeth 13, and the first control body 11 is provided with an mounting position 14 for mounting the mechanism such that the driving teeth 13 mesh with the lens 3.

Further, the driving teeth 13 are located at one end of the first control body 11, and the mounting position 14 is a mounting hole located at the other end of the first control body 11.

Further, the first control body 11 is movably provided with a first hand-twist assembly 15 for locking an external circular tube (e.g., circular tube 16) in the mounting hole, and the front end of the first hand-twist assembly 15 extends to the side edge of the mounting hole.

Further, the first control body 11 is further provided with a first control key 111.

Further, the driving assembly 12 includes a driving motor 121 and a driven wheel 122. The driving motor 121 is fixedly arranged on the first control body 11, and the driven wheel 122 is movably arranged in the first control body 11, and the driving motor 121 is connected to the driving teeth 13 through the driven wheel 122 to drive the driving teeth 13 to rotate. Specifically, a driving wheel 123 is fixed on the shaft of the driving motor 121, and the driving wheel 123 meshes with the driven wheel 122, and the driven wheel 122 meshes with the driving teeth 13.

Further, the driving assembly 12 further includes a first circuit board 16, the first circuit board 16 is arranged in the first control body 11, and the driving motor 121 and the first control key 111 are connected to the first circuit board 16. The first circuit board 16 is provided with a wireless module, a driving module and a processing module. The wireless module of the first circuit board 16 receives the signal instruction from the external structure, and the control module processes the signal instruction and sends out the motor control instruction to control the driving motor 121.

Further, the first hand-twist assembly 15 includes a first hand-twist part 151 and a first pressing block 152. The first hand-twist part 151 is movably arranged on the first control body 11, and the front end of the first hand-twist part 151 extends into the side edge of the mounting hole. The first pressing block 152 is arranged at the front end of the first hand-twist part 151, and when the first hand-twist part 151 moves on the first control body 11, it drives the first pressing block 152 to press or loosen the external circular tube 5 in the mounting hole.

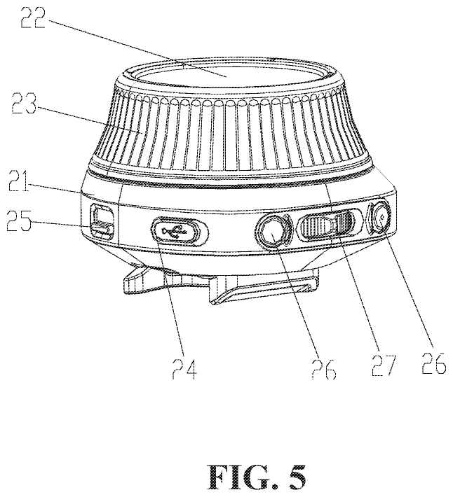

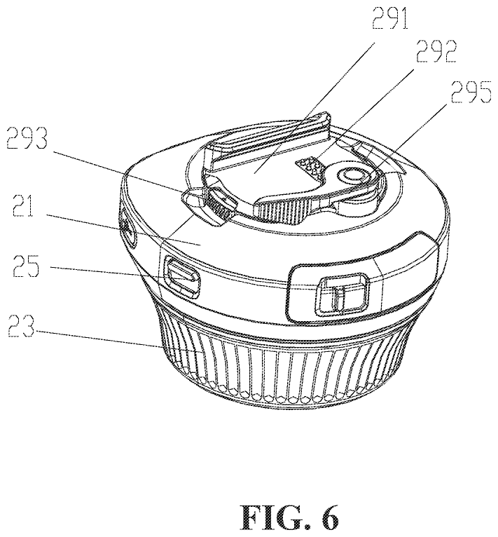

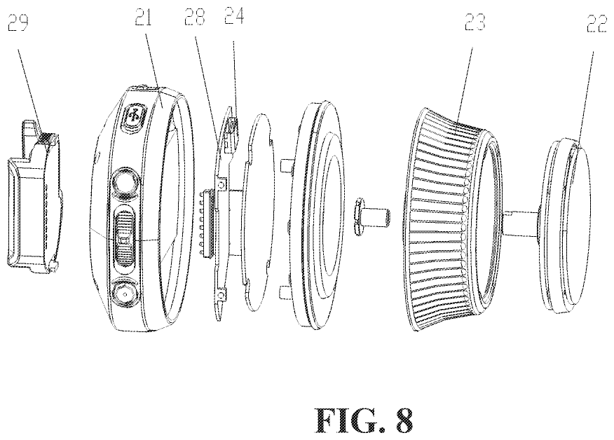

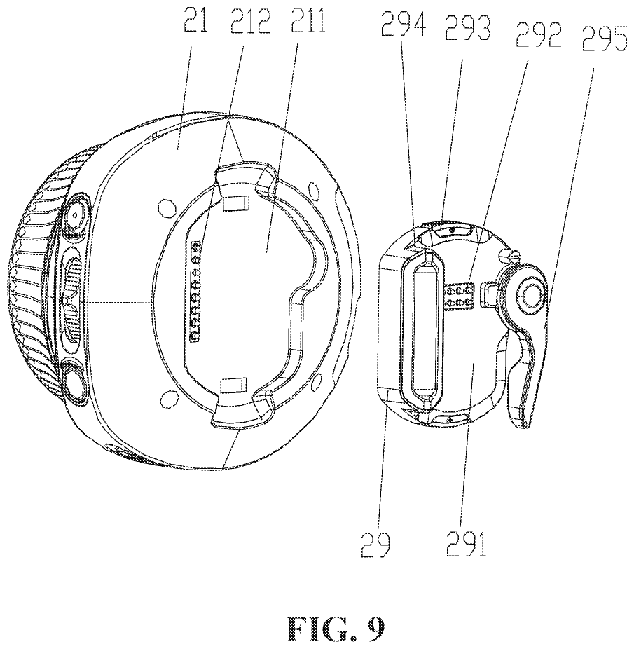

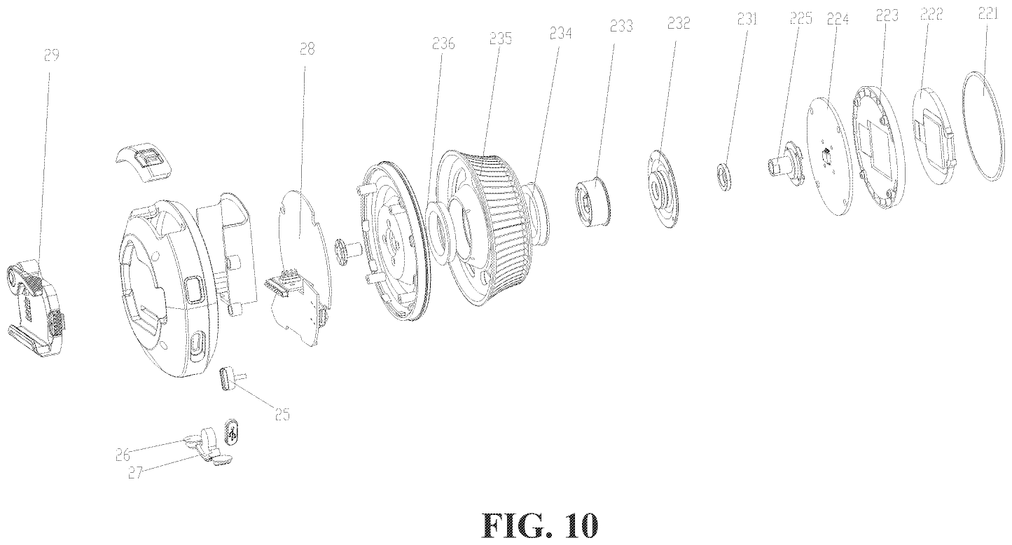

Referring to FIGS. 1 to 10, a control device includes a lens control mechanism 1 and a control handwheel mechanism 2 wirelessly connected to an external camera 4. The control handwheel mechanism 2 is wired or wirelessly connected to the lens control mechanism 1. The control handwheel mechanism 2 includes a second control body 21, a touch screen assembly 22 for controlling the parameters of the external camera 4, and a handwheel assembly 23 for controlling the lens control mechanism 1. The touch screen assembly 22 is fixedly arranged on the second control body 21, and the handwheel assembly 23 is rotatably and movably arranged on the second control body 21.

Further, the control handwheel mechanism 2 is wirelessly connected to the lens control mechanism 1.

Further, the number of the lens control mechanisms 1 can be two or more (e.g., a first lens control mechanism and a second lens control mechanism), the first control body 11 is provided with a plurality of first interfaces 17, and the two lens control mechanisms 1 are connected in series through the first interfaces 17. The second control body 21 is provided with a second interface 24, and the control handwheel mechanism 2 and the lens control mechanism 1 are wired through the second interface 24 and the first interface 17. The first interface 17 and the second interface 24 may both be Type-C interfaces. The first interface 17 is connected to the first circuit board 16, and the two lens control mechanisms 1 are connected in series through the first interface 17, such that the control handwheel mechanism 2 may be wired with the two lens control mechanisms 1, and control the two lens control mechanisms 1 simultaneously, or supply power simultaneously.

Further, the handwheel assembly 23 is arranged around the touch screen assembly 22. The structural arrangement of the handwheel assembly 23 and the touch screen assembly 22 may be, for example, equivalent to the structural arrangement of a knob switch (Chinese Patent Application CN202022068003.2) or a knob touch screen of an air-conditioning panel with knob touch screen (Chinese Patent Application CN202221460375.2) in the prior applications.

Further, the second control body 21 is movably provided with a limit switch 25 for limiting the rotation angle of the handwheel assembly 23. Specifically, the limit switch 25 may be toggled up and down in the second control body 21. When the limit switch 25 is toggled up, it is open to limit the handwheel assembly 23 to rotate within a certain angle. When the limit switch 25 is toggled down, it is closed to release the rotation limit of the handwheel assembly 23.

Further, the second control body 21 is further provided with a second key 26 for controlling the lens control mechanism 1. There may be two second keys 26.

Further, the second control body 21 is further provided with a lever 27 for controlling the lens control mechanism 1.

Further, the control handwheel mechanism 2 further includes a second circuit board 28, the second circuit board 28 is provided with a wireless communication module, a power supply module, a vibration module, a display module and an information processing module. The second circuit board 28 is wirelessly connected to the external camera 4 and the lens control mechanism 1 through a wireless communication module, and supplies power through a power supply module (the battery 5 connected to the power supply module may be arranged in the control handwheel mechanism 2, or the control handwheel mechanism 2 is provided with a power interface connected to the power supply module). Through the information processing module and the display module, the information input or display of the second key 26, the lever 27, the touch screen assembly 22 and the handwheel assembly 23 is achieved.

By toggling the lever 27 left and right, the second circuit board 28 receives and processes signals, and sends control signals to the lens control mechanism 1, thereby operating the lens control mechanism 1 and controlling the parameters of the lens 3. When the second key 26 is pressed, the second circuit board 28 receives and processes signals, and sends the control signal to the lens control mechanism 1, thereby operating the lens control mechanism 1 and controlling the parameters of the lens 3. Further, specifically, the handwheel assembly 23 and the lever 27 may control the two lens control mechanisms 1 simultaneously, thereby controlling the parameters of the two lenses 3 simultaneously.

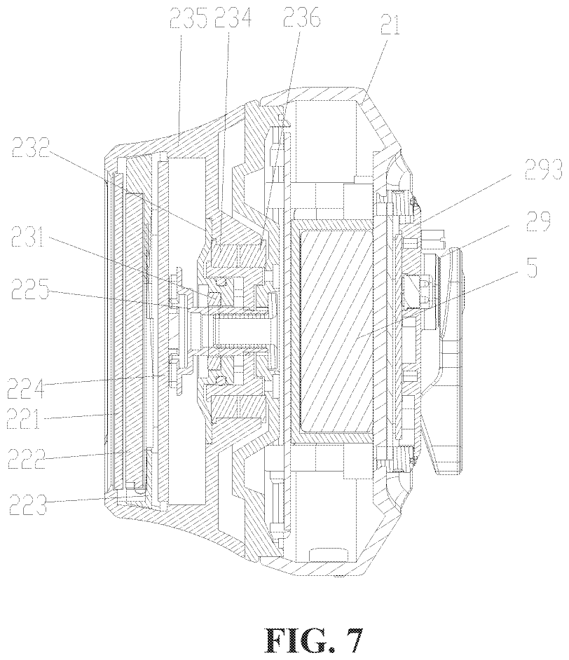

Referring to FIGS. 7 to 10, further, the touch screen assembly 22 includes tempered glass 221, a touch screen 222, a fixing frame 223, a touch screen circuit board 224 and a supporting frame 225. The touch screen 222 is arranged in the fixing frame 223 and connected to the touch screen circuit board 224. The tempered glass 221 is stuck on the touch screen 222. The fixing frame 223 is fixedly arranged on the upper side of the touch screen circuit board 224. One end of the supporting frame 225 is fixed on the lower side of the touch screen circuit board 224, and the other end of the supporting frame 225 is fixedly arranged on the second control body 21. The touch screen circuit board 224 is connected to the second circuit board 28.

Further, the handwheel assembly 23 includes a radial magnet 231, a cover plate 232, a sleeve 233, a first flange bearing 234, a handwheel 235 and a second flange bearing 236. The first flange bearing 234 and the second flange bearing 236 are fitted into the handwheel 235. The sleeve 233 passes through the first flange bearing 234 and the second flange bearing 236, and its end face presses the inner ring of the first flange bearing 234. The cover plate 232 is connected to the handwheel 235, the end face presses the outer ring of the handwheel 235, and the radial magnet 231 is connected to the center of the cover plate 232. The handwheel 235 may rotate relative to the second control body 21, and when the handwheel 235 rotates, it drives the radial magnet 231 to rotate to cause magnetic field changes. The touch screen circuit board 224 receives magnetic field signals and processes information. That is, when the rotary handwheel assembly 23 is rotated, magnetic field signals are sent out, and the touch screen circuit board 224 on the touch screen assembly 22 receives and processes the signals. On the one hand, when rotating the handwheel assembly 23, the parameters of the control handwheel mechanism 2 and the camera 4 can be controlled; on the other hand, when rotating the handwheel assembly 23, the operation of the driving motor 121 of the lens control mechanism 1 can be controlled in real-time, thereby controlling the parameters of the lens 3.

Further, the handwheel assembly 23 and the touch screen assembly 22 are located at one side of the second control body 21. The other side of the second control body 21 is provided with a mounting groove 211, a first electronic contact pin 212 is arranged in the mounting groove 211, and a mounting assembly 29 is detachably arranged in the mounting groove 211. The mounting assembly 29 is electrically connected to the control handwheel mechanism 2 through the first electronic contact pin 212, the mounting assembly 29 is provided with a mounting position 291 for detachably connecting an external device, and the mounting position 291 is internally provided with a second electronic contact pin 292 for electrically connecting with an external device.

Specifically, the mounting assembly 29 includes a mounting button 293, a mounting body 294, and a second locking hand-twist part 295. There are two mounting buttons 293, the two mounting buttons 293 are movably connected to both ends of the mounting body 29, and a spring is arranged between the mounting buttons 293 and the mounting body 294. When the mounting assembly 29 abuts against the mounting groove 211, one side of the mounting assembly 29 is electrically connected to the first electronic contact pin 212, and the mounting button 293 abuts against the side of the mounting groove 211 under the action of the spring to achieve mounting of the mounting assembly 29. The mounting position 291 is arranged on the other side of the mounting body 294. The second electronic contact pin 292 is located in the middle of the other side of the mounting body 294, and serves as an electronic port for connecting the control handwheel mechanism 2 with an external device. The second locking hand-twist part 295 is movably connected to the mounting body 294, and an external device can be connected to the mounting body 29 by rotating the second locking hand-twist part 295.

Specifically, the control methods and control principles of the touch screen assembly 22, the handwheel assembly 23, the second key 26, the lever 27 and other structures belongs to the prior art. The touch screen assembly 22 may control the parameter settings of the control handwheel mechanism 2 (information such as touch screen brightness, wireless channel/response speed/response strength of the lens control mechanism 1, and display information of the lens and camera). The handwheel 23 may control the parameter settings (recording, aperture, picture and other information) of the camera 4. The second key 26 and the lever 27 may control the parameter settings (follow focus, zoom and aperture) of the lens 3. In addition, the touch screen assembly 22 may trigger the auto-focusing function of the camera 4, send an auto-focusing instruction to the lens control mechanism 1 through the camera 4 (the lens control mechanism 1 and the camera 4 may also be connected wirelessly), and drive the lens control mechanism 1 to control parameters such as follow focus and zoom of the lens 3. The specific implementation of the control methods focuses on the structural design and connection relationship of the lens control mechanism and the control handwheel mechanism.

The above are only exemplary embodiments of the present invention, and are not intended to limit the present invention. Any modification, equivalent substitution and improvement made within the spirit and principle of the present invention shall fall within the scope of protection of the present invention.

The above are only examples of the present disclosure, and are not intended to limit the present disclosure. Any modifications, equivalent replacements and improvements made within the spirit and principle of the present disclosure shall fall within the scope of protection of the present disclosure.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-10 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-10 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

What is claimed is:

1. A lens control mechanism for a lens, comprising:
a first control body;
a driving assembly; and
driving teeth configured to mesh with the lens,
wherein the driving teeth are movably arranged on the first control body, the driving assembly is fixedly arranged on the first control body, the driving assembly is drivingly connected to the driving teeth, and the first control body is provided with a mounting position for mounting the lens control mechanism such that the driving teeth mesh with the lens.

2. The lens control mechanism according to claim 1,
wherein the driving teeth are located at one end of the first control body, and the mounting position is a mounting hole located at the other end of the first control body; and
wherein the first control body is movably provided with a first hand-twist assembly for locking an external circular tube in the mounting hole, and a front end of the first hand-twist assembly extends to a side edge of the mounting hole.

3. A control device, comprising:
the lens control mechanism according to claim 1; and
a control handwheel mechanism wirelessly connected to an external camera,
wherein the control handwheel mechanism is connected to the lens control mechanism,
the control handwheel mechanism comprises:
a second control body;
a touch screen assembly configured to control at least one of the external camera or the lens control mechanism; and
a handwheel assembly configured to control at least one of the external camera or the lens control mechanism,
wherein the touch screen assembly is fixedly arranged on the second control body, and the handwheel assembly is rotatably and movably arranged on the second control body.

4. The control device according to claim 3,
wherein the driving teeth are located at one end of the first control body, and the mounting position is a mounting hole located at the other end of the first control body; and
wherein the first control body is movably provided with a first hand-twist assembly for locking an external circular tube in the mounting hole, and a front end of the first hand-twist assembly extends to a side edge of the mounting hole.

5. The control device according to claim 3, wherein the control handwheel mechanism is wirelessly connected to the lens control mechanism.

6. The control device according to claim 3, wherein the lens control mechanism comprises a first lens control mechanism and a second lens control mechanism,
the first control body is provided with a plurality of first interfaces, the first lens control mechanism and the second lens control mechanism are connected in series through the plurality of first interfaces,
the second control body is provided with a second interface, and the control handwheel mechanism and the lens control mechanism are wired through the second interface and the plurality of first interfaces.

7. The control device according to claim 3, wherein the handwheel assembly is arranged around the touch screen assembly.

8. The control device according to claim 3, wherein the second control body is movably provided with a limit switch configured to limit a rotation angle of the handwheel assembly.

9. The control device according to claim 3, wherein the second control body is further provided with a second key configured to control at least one of the external camera or the lens control mechanism.

10. The control device according to claim 3, wherein the second control body is further provided with a lever configured to control the lens control mechanism.

11. The control device according to claim 3, wherein the handwheel assembly and the touch screen assembly are located at a first side of the second control body, a second side of the second control body is provided with a mounting groove, a first electronic contact pin is arranged in the mounting groove, a mounting assembly is detachably arranged in the mounting groove, the mounting assembly is electrically connected to the control handwheel mechanism through the first electronic contact pin, the mounting assembly is provided with a mounting position for detachably connecting an external device, and the mounting position is internally provided with a second electronic contact pin for electrically connecting with an external device.
